(19) United States
(12) Patent Application Publication
(10) Pub. No.: US 2015/0381291 A1
(43) Pub. Date: Dec. 31, 2015

(54) Tiered Approach to Radio Frequency (RF) Co-existence

(71) Applicant: QUALCOMM Incorporated, San Diego, CA (US)

(72) Inventors: Amit Mahajan, San Diego, CA (US); Alexei Yurievitch Gorokhov, San Diego, CA (US); Francis Ming-Meng Ngai, Louisville, CO (US)

(21) Appl. No.: 14/703,303

(22) Filed: May 4, 2015

Related U.S. Application Data
(60) Provisional application No. 62/018,546, filed on Jun. 28, 2014.

(51) Int. Cl. H04B 15/00; H04W 24/08

(52) U.S. Cl. CPC H04B 15/00; H04W 24/08; H04W 88/02

(57) ABSTRACT

Various embodiments implemented on a mobile communication device leverage the availability of a plurality of coexistence mitigation strategies to choose a coexistence mitigation strategy that may be most successful in avoiding and/or mitigating coexistence interference between an aggressor RAT and a victim RAT. In response to determining that a coexistence event between the aggressor RAT and the victim RAT is occurring or is about to occur, a processor on the mobile communication device may determine various priority criteria related to the mobile communication device's current circumstances (e.g., network resources, device resources, etc.) and/or related to each available coexistence mitigation strategy. Using these determined priority criteria, the device processor may select and implement a coexistence mitigation strategy that may be the most suitable for avoiding/mitigating coexistence interference between the aggressor RAT and the victim RAT given the current condition, circumstances, etc. of the mobile communication device.

### RELATED APPLICATIONS

This application claims the benefit of priority to U.S. Provisional Patent Application No. 62/018,546 entitled “Tiered Approach to Radio Frequency (RF) Coexistence” filed Jun. 28, 2014, the entire contents of which are incorporated herein by reference.

### BACKGROUND

Some new designs of mobile communication devices—such as smart phones, tablet computers, and laptop computers—include two or more radio access technologies (“RATs”) that enable the devices to connect to two or more radio access networks. Examples of radio access networks include Third Generation (G-3), Fourth Generation (G-4), Long Term Evolution (LTE), Time Division Multiple Access (TDMA), Code Division Multiple Access (CDMA), Wideband CDMA (WCDMA), Global System for Mobile (GSM), and Universal Mobile Telecommunications Systems (UMTS). Such mobile communication devices (sometimes referred to as “multi-active communication devices”) may also include two or more radio-frequency (RF) communication circuits or “RF resources” to provide users with access to separate networks via the two or more RATs.

Multi-active communication devices may include mobile communication devices (i.e., multi-Subscriber-Identity-Module (SIM), multi-active or “MSMA” communication devices) with a plurality of SIM cards that are each associated with a different RAT and utilize a different RF resource to connect to a separate mobile telephony network. An example multi-active communication device is a “dual-SIM-dual-active” or “DSDA” communication device, which includes two SIM cards/subscriptions associated with two mobile telephony networks. Some newer multi-active communication devices may include one or more SIMs/subscriptions capable of using multiple RATs (sometimes referred to as “global mode” subscriptions) simultaneously or at different times. For example, a global mode subscription may be included on a single-SIM communication device, such as a simultaneous GSM+LTE (“SGLTE”) communication device, which includes one SIM card/subscription associated with two RATs that each use an RF resource to connect to two separate mobile networks simultaneously on behalf of the one subscription.

When a mobile communication device includes a plurality of RATs, each RAT on the device may utilize a different RF resource to communicate with its associated network at any time. For example, a first RAT (e.g., a GSM RAT) may use a first transceiver to transmit to a GSM base station at the same time a second RAT (e.g., a WCDMA RAT) uses a second transceiver to transmit to a WCDMA base station. However, because of the proximity of the antennas of the RF resources included in a multi-active communication device, the simultaneous use of the RF resources may cause one or more RF resources to desensitize or interfere with the ability of the other RF resources to operate normally.

Generally, receiver desensitization (referred to as “de-sense”), or degradation of receiver sensitivity, may result from noise interference of a nearby transmitter. For example, when two radios are close together with one transmitting on the uplink—the aggressor communication activity (“aggressor”)—and the other receiving on the downlink—the victim communication activity (“victim”)—signals from the aggressor's transmitter may be picked up by the victim's receiver or otherwise interfere with reception of a weaker signal (e.g., from a distant base station). As a result, the received signals may become corrupted and difficult or impossible for the victim to decode. Receiver de-sense presents a design and operational challenge for multi-radio devices, such as multi-active communication devices, due to the necessary proximity of transmitters in these devices.

### SUMMARY

Various embodiments provide methods, devices, and non-transitory processor-readable storage media for selecting a coexistence mitigation strategy in response to detecting an occurrence of a coexistence event between a first radio access technology (RAT) and a second RAT in a mobile communication device. Some embodiment methods may include determining a first set of priority criteria for a plurality of coexistence mitigation strategies during the coexistence event, where the first set of priority criteria includes performance criteria of the first RAT and the second RAT, respectively, and determining a first ranking for the plurality of coexistence mitigation strategies based on a degree to which each coexistence mitigation strategy satisfies the first set of priority criteria during the coexistence event. In such embodiments the method may further include implementing a highest ranked coexistence mitigation strategy in the first ranking, determining, for each implemented coexistence mitigation strategy, whether measured performance of the first RAT and the second RAT satisfy the first set of priority criteria after implementing the coexistence mitigation strategy, and implementing a next highest ranked coexistence mitigation strategy in the first ranking when the measured performance of the first and second RAT does not satisfy the first set of priority criteria.

In some embodiments, the first set of priority criteria may include one or more parameters of voice quality, data throughput, error rate, transmission power, mobile communication device resources, and network resources. In some embodiments, determining the first ranking may include determining predicted values of one or more of the first set of priority criteria for each of the plurality of coexistence mitigation strategies during the coexistence event. In some embodiments, the mobile communication device may be a multi-Subscriber-Identity-Module (SIM), multi-active mobile communication device.

In some embodiments, the method may further include determining whether a change in the coexistence event between the first RAT and the second RAT has occurred, determining a second set of priority criteria for the plurality of coexistence mitigation strategies in response to determining that a change in the coexistence event between the first RAT and the second RAT has occurred, where the second set of priority criteria includes performance criteria of the first RAT and the second RAT, respectively, determining a second ranking for the plurality of coexistence mitigation strategies based on a degree to which each coexistence mitigation strategy satisfies the second set of priority criteria during the changed coexistence event, and implementing a highest ranked coexistence mitigation strategy in the second ranking in response to determining a change in the coexistence event.

In some embodiments, the plurality of coexistence mitigation strategies may include any combination of two or more of frequency-band reselection, RAT reselection, transmit power backoff, and transmit power blanking. In some embodiments, determining a first set of priority for each of a plurality of coexistence mitigation strategies during the coexistence event may include ranking the plurality of coexistence mitigation strategies according to a number of priority criteria in the first set of priority criteria that each of the plurality of coexistence mitigation strategies is predicted to satisfy during the coexistence event.

In some embodiments, implementing a highest ranked coexistence mitigation strategy in the first ranking may include determining whether implementing the highest ranked coexistence mitigation strategy is feasible and permissible, and implementing the highest ranked coexistence mitigation strategy in response to determining that the highest ranked coexistence mitigation strategy is feasible and permissible. In such embodiments, the method may further include determining whether implementing a next highest ranked coexistence mitigation strategy is feasible and permissible in response to determining that implementing the highest ranked coexistence mitigation strategy is at least one of not feasible or not permissible, and implementing the next highest coexistence mitigation strategy in response to determining that the next highest ranked coexistence mitigation strategy is feasible and permissible. In response to determining that the highest ranked coexistence mitigation strategy is at least one of not feasible or not permissible, the method may further include incrementally evaluating each coexistence mitigation strategy in rank order for feasibility and permissibility until either a feasible and permissible coexistence mitigation strategy is identified or all coexistence mitigation strategies have been evaluated, implementing a highest ranked coexistence mitigation strategy determined to be feasible and permissible, and implementing a default coexistence mitigation strategy if all coexistence mitigation strategies have been evaluated and none are determined to feasible and permissible.

Various embodiments may include a mobile communication device configured with processor-executable instructions to perform operations of the methods described above.

Various embodiments may include non-transitory processor-readable media on which is stored processor-executable instructions configured to cause a processor of a mobile communication device to perform operations of the methods described above.

Various embodiments may include a mobile communication device having means for performing functions of the operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of mobile telephony networks suitable for use with various embodiments.

FIG. 2 is a component block diagram of a multi-active communication device according to various embodiments.

FIG. 3 is a component block diagram illustrating the interaction between components of different transmit/receive chains in a multi-active communication device according to various embodiments.

FIGS. 4A-4B are component block diagrams illustrating examples of acquiring service with combinations of RATs that avoid the possibility of inter-RAT coexistence interference according to various embodiments.

FIGS. 5A-5B are example data tables including information regarding available and interfering frequency bands for a plurality of RATs operating on a multi-active communication device according to various embodiments.

FIG. 6 is a component diagram illustrating Tx blanking and Tx power backoff during an RF coexistence event.

FIG. 7 is a process flow diagram illustrating a method for implementing a coexistence mitigation strategy in a plurality of coexistence mitigation strategies based on priority criteria of the plurality of coexistence mitigation strategies according to various embodiments.

FIG. 8 is a process flow diagram illustrating a method for attempting to implement one of a plurality of coexistence mitigation strategies based on an example ranking of coexistence mitigation strategies according to various embodiments.

FIG. 9 is a component block diagram of a multi-SIM multi-active communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the terms “multi-active communication device” and “mobile communication device” are used interchangeably and refer to any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices that include a programmable processor, memory, and circuitry for connecting to at least two mobile communication networks. The various aspects may be useful in mobile communication devices, such as smart phones, and so such devices are referred to in the descriptions of various embodiments. However, the embodiments may be useful in any electronic devices—such as a DSDA communication device or an SGLTE communication device—that may individually maintain a plurality of RATs that may simultaneously utilize a plurality of separate RF resources.

Multi-active communication devices have a plurality of RF resources capable of supporting a plurality of RATs capable of receiving and transmitting simultaneously. As described, one or more RATs on a multi-active communication device may negatively affect the performance of other RATs operating on the multi-active communication device. For example, a multi-active communication device may suffer from inter-RAT coexistence interference when an aggressor RAT is attempting to transmit while a victim RAT is simultaneously attempting to receive transmissions. During such a “coexistence event,” the aggressor RAT's transmissions may cause severe impairment to the victim RAT's ability to receive transmissions. This interference may be in the form of blocking interference, harmonics, intermodulation, and other noises and distortion received by the victim. Such interference may significantly degrade the victim RAT's receiver sensitivity, voice call quality, and data throughput. These effects may also result in a reduced network capacity.

Currently, many solutions for mitigating victim RAT de-sense may be implemented on multi-active communication devices. For example, in some solutions, a multi-active communication device configures the aggressor RAT to reduce or zero its transmit power while the victim RAT is receiving transmissions. In other words, the device reduces the aggressor RAT's transmit power (sometimes referred to as implementing transmit (“Tx”) power backoff) or, in some extreme cases, zeroes the aggressor RAT's transmit power (sometimes referred to as implementing “Tx blanking”) in order to reduce or eliminate the victim RAT's de-sense. However, solutions such as implementing Tx power backoff or Tx blanking increases the error probability of subsequently received information from the network and decreases the aggressor RAT's overall throughput. Further, such solutions incur a cost on the link-level performance of the aggressor RAT and/or impact the aggressor RAT's reverse link throughput. While current solutions for utilizing Tx blanking/Tx power backoff are effective in reducing the victim RAT's de-sense, the improvement to the victim RAT's reception performance is often at the expense of the aggressor RAT's performance.

Multiple frequency bands/channels may be available to a RAT at any given time, and some solutions for reducing inter-RAT coexistence interference configure RATs operating on the same communication device to utilize operating frequency bands that avoid RAT de-sense. Specifically, in these solutions, the communication device informs a RAT's network in the event that transmission/reception of radio signals would benefit or no longer benefit from using certain carriers or frequency resources, for example, by signaling the network that certain frequency bands are not useable due to in-device coexistence. However, these solutions are ineffective in circumstances in which interfering RATs do not have a frequency-band/channel combination that avoids inter-RAT coexistence interference and, as a result, do nothing to prevent or avoid a victim RAT's de-sense.

In some other solutions, multi-active communication devices perform RAT reselection in response to determining that a RAT is currently being de-sensed by another RAT. In these solutions, the multi-active communication device may utilize a combination of RATs that will not interfere with each other. However, such solutions may be limited to mobile communication devices that support more than two RATs, and therefore, RAT reselection as a general solution for inter-RAT coexistence may not be practical in most mobile-communication-device configurations.

Typically, solutions for avoiding/mitigating coexistence interference/de-sense implement only one type of coexistence mitigation strategy (e.g., Tx blanking/power backoff, frequency band/channel reselection, or RAT reselection). As described, each of these coexistence mitigation strategies may be useful in some circumstances, but may be comparatively ineffective or detrimental to the overall performance of the mobile communication device in other instances. Thus, by attempting to resolve coexistence interference using only one type of coexistence mitigation strategy, solutions are inflexible and unable to dynamically utilize a mitigation strategy that may currently be the most suitable for avoiding/mitigating coexistence interference.

To improve the avoidance and management of inter-RAT coexistence interference the various embodiments dynamically assess the relative usefulness or potential success of implementing multiple coexistence mitigation strategies in order to select the most appropriate or preferred strategy under the current circumstances, network policies and limitations, and capabilities of the mobile communication device.

In overview, various embodiments implemented on a mobile communication device (e.g., a multi-active communication device) leverage the availability of a plurality of alternative coexistence mitigation strategies by ranking the various coexistence mitigation strategies in a hierarchical manner in order to choose a particular coexistence mitigation strategy that is determined to be better suited or more successful in avoiding and/or mitigating coexistence interference between an aggressor RAT and a victim RAT. Specifically, in response to determining that a coexistence event between the aggressor RAT and the victim RAT is occurring or is about to occur, a processor on the mobile communication device may determine various priority criteria related to the mobile communication device's current circumstances during the coexistence event. The priority criteria may include performance criteria for the aggressor RAT and the victim RAT (e.g., voice quality, data throughput, error rates, transmission power, network resources used by the RATs, device resources used by the RATs, etc.), and/or related criteria for each available coexistence mitigation strategy. Using these determined priority criteria, the device processor may rank order or otherwise generate a hierarchical rating (e.g., a list) of the available coexistence mitigation strategies based on their suitability (i.e., with respect to the performance criteria) during the current coexistence event. Using the hierarchical rating (or list) of the available coexistence mitigation strategies, the device processor may select and implement a coexistence mitigation strategy that may be the most suitable (i.e. highest ranked) for avoiding/mitigating coexistence interference between the aggressor RAT and the victim RAT given the current condition, circumstances, networks, current communication activities, etc. of the mobile communication device. Performance measurements of the aggressor and victim RATs may then be used to determine whether the implemented is satisfying the various priority criteria, and if not, a next highest ranked coexistence mitigation strategy in the hierarchical rating of the available coexistence mitigation strategies may be implemented. As a result, the aggressor RAT may experience overall higher performance, and the victim RAT may experience less de-sense and/or performance degradation in comparison to mobile communication devices that focus on resolving coexistence interference using only one type of coexistence mitigation strategy.

In some embodiments, the device processor may select or determine a particular set of priority criteria to use in ranking available coexistence mitigation strategies depending on the nature of the coexistence event, device operating conditions and other circumstances, and use the selected or determined priority criteria to generate the ranking or hierarchy of coexistence mitigation strategies. The ranking may represent a hierarchy, priority or preference among the plurality of coexistence mitigation strategies available to the mobile communication device for the particular coexistence event. Thus, the ranking may represent a degree to which each coexistence mitigation strategy satisfies the priority criteria for both RATs during the current or impending coexistence event. Specifically, the device processor may determine the benefits (and/or detriments or limitations) of implementing each coexistence mitigation strategy based on the current circumstances, cause of the coexistence event, operating state, available resources, performance of RATs, and/or condition of the mobile communication device and/or mobile networks that are currently available in the mobile communication device's current location and in the circumstances of the current coexistence event, and the device processor may rank each of the plurality of coexistence mitigation strategies based on their expected effectiveness and resulting performance of both RATs given current conditions. For example, with reference to Tx blanking, the device processor may calculate or estimate the effects of Tx blanking on data throughput for the first subscription and may rank Tx blanking higher or lower depending on the expected loss in data throughput that would occur in the first subscription and the benefits to the second (“victim”) subscription if Tx blanking is implemented.

In various embodiments, the device processor may attempt to implement the highest ranked coexistence mitigation strategy. In other words, the device processor may initially attempt to avoid/mitigate the coexistence interference on the mobile communication device using the highest rank/most preferred coexistence mitigation strategy. The device processor may determine the feasibility and/or permissibility of implementing the highest ranked coexistence mitigation strategy. For example, if frequency band/channel reselection is the highest ranked coexistence strategy, the device processor may determine whether there is any combination of frequency bands/channels available to the first RAT and the second RAT that avoid interference (i.e., whether switching frequency bands/channels is feasible/possible) and/or whether a network operator has indicated that frequency-band reselection is permissible. In response to determining that the highest ranked coexistence mitigation strategy is not permissible and/or not feasible, the device processor may attempt to implement the next highest ranked coexistence mitigation strategy within the determined hierarchy of available coexistence mitigation strategies. In some embodiments, the device processor may continue down the hierarchy or ranked list of available coexistence mitigation strategies and evaluate each one until determining that a coexistence mitigation strategy is feasible/permissible, at which point the device processor may implement that coexistence mitigation strategy to avoid/mitigate de-sense on the mobile communication device.

During implementation of a coexistence mitigation strategy, the device processor may measure the performance of the first and second RATs with respect to the determined priority criteria. For example, if the priority criteria include data throughput thresholds, the device processor may measure the data throughput of the first and second RATs during the coexistence event and compare the measured values to the threshold criteria. If the measured performance of the first and second RATs do not satisfy the priority criteria (e.g. if the RATs do not perform as well as predicted under the implemented coexistence mitigation strategy), the mobile communication device may select and implement the next highest ranked available coexistence mitigation strategy. This process of implementing an available coexistence mitigation strategy based on its ranking, evaluating performance of the RATs while implementing that strategy, and implementing a next highest rank coexistence mitigation strategy if the priority criteria are not satisfied may continue through the determined hierarchy of available coexistence mitigation strategies.

In some embodiments, after implementing a coexistence mitigation strategy, the coexistence conditions surrounding the aggressor RAT and the victim RAT may change. For example, the mobile communication device may enter a new geographic location that has different frequency bands available and/or is served by networks that implement different permissions for RAT reselection, etc. Thus, in response to determining that there has been a change in the coexistence event between the aggressor RAT and the second RAT, the device processor may repeat the operations of determining a set of priority criteria suitable for the changed coexistence event, ranking the plurality of coexistence mitigation strategies (e.g., in a second ranking) based on the new priority criteria, and attempting to implement the highest ranked strategies within the newly determined hierarchy of available coexistence mitigation strategies. This process of developing a new set of priority criteria suitable for the coexistence event, re-ranking the plurality of coexistence mitigation strategies based on the new priority criteria, and attempting to implement the highest ranked strategies within the newly determined hierarchy of available coexistence mitigation strategies may be repeated each time the circumstances or conditions of the coexistence event change. In this manner, a coexistence mitigation strategy may be implemented at all times that provides performance improvements for both RATs compared to conventional methods that implement a single mitigation strategy based on limited and unchanging criteria.

The RATs' activities may change during the ordinary course of operating on a mobile communication device, such as when a RAT ceases a transmission cycle and begins a reception cycle or vice versa. Thus, an aggressor RAT at a first time may become a victim RAT at a second time, and the victim RAT at the first time may similarly become an aggressor RAT at a second or third time. Thus, while various embodiments may be described with reference to an aggressor RAT and a victim RAT, the RATs may be referred to generally as a first RAT and a second RAT to reflect that the RATs' roles as an aggressor communication activity or a victim communication activity may change. To address this, the embodiment methods include selecting a set of priority criteria for ranking the plurality of coexistence mitigation strategies for each coexistence event based on the current RAT activities, device state, network conditions, etc.

While the embodiment descriptions refer to a mobile communication device capable of supporting two simultaneously active RATs, the mobile communication device may support two or more simultaneously active RATs in some embodiments. In such embodiments, the device processor may perform operations similar to those described above to avoid potential inter-RAT coexistence interference among two or more simultaneously active RATs on the multi-active communication device. For example, on a mobile communication device capable of supporting three simultaneously active RATs, the device processor may determine whether there is a likelihood of a coexistence event occurring between any of the three RATs (e.g., a first, second, and third RAT) and may attempt to implement a coexistence mitigation strategy that has the highest likelihood of avoiding/mitigating de-sense between those RATs.

Various embodiments may be particularly useful for avoiding or mitigating coexistence interference on mobile communication devices that include multiple SIMs that simultaneously utilize different RATs to communicate with different mobile networks (e.g., a DSDA or MSMA communication device). However, various embodiments may generally be useful for avoiding/mitigating coexistence interference on any mobile communication device that simultaneously utilizes multiple RATs to communicate with separate mobile networks, including a single-SIM, multi-RAT communication device or SGLTE communication device.

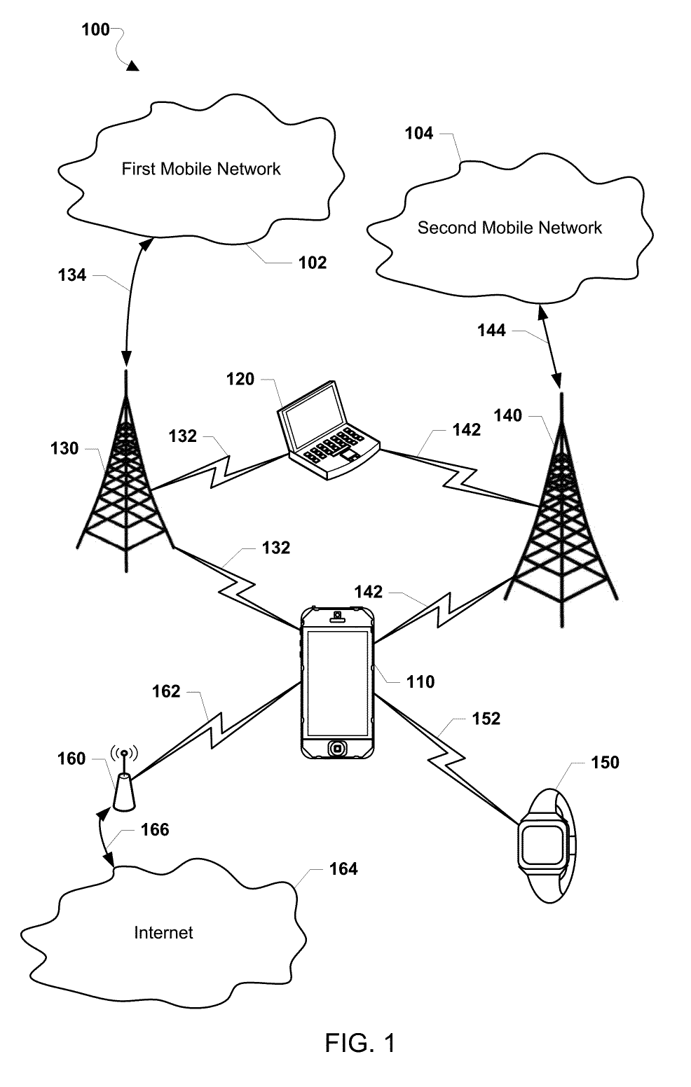

Various embodiments may be implemented within a variety of communication systems 100 that include at least two mobile telephony networks, an example of which is illustrated in FIG. 1. A first mobile network 102 and a second mobile network 104 typically each include a plurality of cellular base stations (e.g., a first base station 130 and a second base station 140). A first mobile communication device 110 may be in communication with the first mobile network 102 through a cellular connection 132 to the first base station 130. The first mobile communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second mobile communication device 120 may similarly communicate with the first mobile network 102 through the cellular connection 132 to the first base station 130. The second mobile communication device 120 may communicate with the second mobile network 104 through the cellular connection 142 to the second base station 140. The cellular connections 132 and 142 may be made through two-way wireless communication links, such as 4G, 3G, CDMA, TDMA, WCDMA, GSM, and other mobile telephony communication technologies.

While the mobile communication devices 110, 120 are shown connected to the mobile networks 102, 104, in some embodiments (not shown) the mobile communication devices 110, 120 may include one or more subscriptions to two or more mobile networks 102, 104 and may connect to those networks in a manner similar to operations described above.

In some embodiments, the first mobile communication device 110 may establish a wireless connection 152 with a peripheral device 150 used in connection with the first mobile communication device 110. For example, the first mobile communication device 110 may communicate over a Bluetooth® link with a Bluetooth-enabled personal computing device (e.g., a “smart watch”). In some embodiments, the first mobile communication device 110 may establish a wireless connection 162 with a wireless access point 160, such as over a Wi-Fi connection. The wireless access point 160 may be configured to connect to the Internet 164 or another network over a wired connection 166.

While not illustrated, the second mobile communication device 120 may similarly be configured to connect with the peripheral device 150 and/or the wireless access point 160 over wireless links.

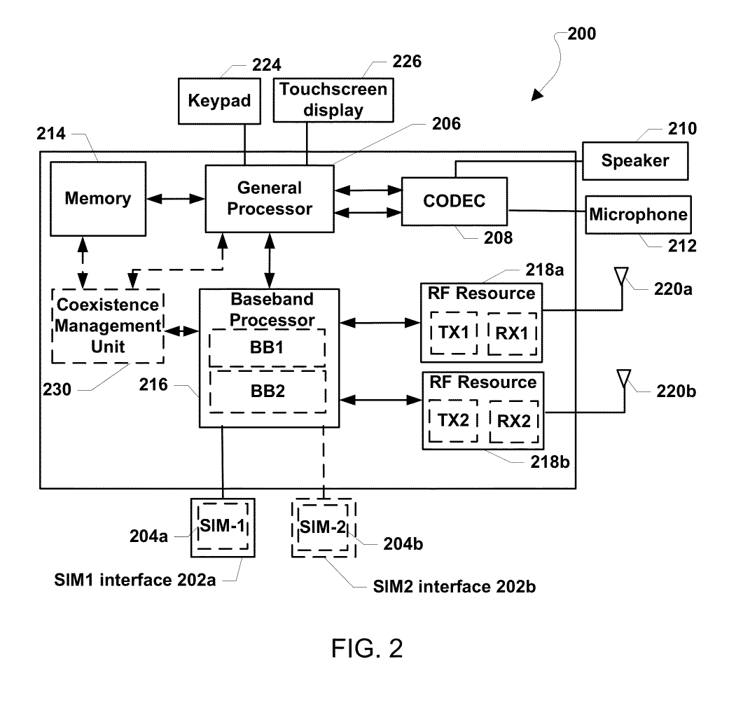

FIG. 2 is a functional block diagram of a mobile communication device 200 suitable for implementing various embodiments. According to various embodiments, the mobile communication device 200 may be similar to one or more of the mobile communication devices 110, 120 as described with reference to FIG. 1. With reference to FIGS. 1-2, the mobile communication device 200 may include a first SIM interface 202a, which may receive a first identity module SIM-1 204a that is associated with a first subscription and/or RAT. In optional embodiments, the mobile communication device 200 may optionally include a second SIM interface 202b, which may receive an optional second identity module SIM-2 204b that is associated with a second subscription and/or RAT.

A SIM in various embodiments may be a Universal Integrated Circuit Card (UICC) that is configured with SIM and/or Universal SIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a central processing unit (CPU), read-only memory (ROM), random access memory (RAM), electrically erasable programmable read-only memory (EEPROM), and input/output (I/O) circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home Public Land Mobile Number (HPLMN) code, etc.) to indicate the SIM card network operator provider. An Integrated Circuit Card Identity (ICCID) SIM serial number is printed on the SIM card for identification. However, a SIM may be implemented within a portion of memory of the mobile communication device 200 (e.g., memory 214), and thus need not be a separate or removable circuit, chip or card.

The mobile communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data, such as an array data structure.

The general processor 206 and the memory 214 may each be coupled to at least one baseband modem processor 216. Each SIM in the mobile communication device 200 (e.g., the SIM-1 204a and the SIM-2 204b) may be associated with a baseband-RF resource chain. A baseband-RF resource chain may include the baseband modem processor 216, which may perform baseband/modem functions for communicating with/controlling a RAT, and may include one or more amplifiers and radios, referred to generally herein as RF resources (e.g., RF resources 218a, 218b). In some embodiments, baseband-RF resource chains may share the baseband modem processor 216 (i.e., a single device that performs baseband/modem functions for all SIMs on the mobile communication device 200). In other embodiments, each baseband-RF resource chain may include physically or logically separate baseband processors (e.g., BB1, BB2).

In some embodiments, the RF resources 218a, 218b may be associated with different RATs. For example, a first RAT (e.g., a GSM RAT) may be associated with the RF resource 218a, and a second RAT (e.g., a CDMA or WCDMA RAT) may be associated with the RF resource 218b. The RF resources 218a, 218b may each be transceivers that perform transmit/receive functions on behalf of their respective RATs. The RF resources 218a, 218b may also include separate transmit and receive circuitry, or may include a transceiver that combines transmitter and receiver functions. The RF resources 218a, 218b may each be coupled to a wireless antenna (e.g., a first wireless antenna 220a or a second wireless antenna 220b). The RF resources 218a, 218b may also be coupled to the baseband modem processor 216.

In some embodiments, the general processor 206, the memory 214, the baseband processor(s) 216, and the RF resources 218a, 218b may be included in the mobile communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the mobile communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the mobile communication device 200 to enable communication between them, as is known in the art.

Functioning together, the two SIMs 204a, 204b, the baseband modem processor 216, the RF resources 218a, 218b, and the wireless antennas 220a, 220b may constitute two or more RATs. For example, a SIM, baseband processor and RF resource may be configured to support two different RATs, such as GSM and WCDMA. More RATs may be supported on the mobile communication device 200 by adding more SIM cards, SIM interfaces, RF resources, and/or antennae for connecting to additional mobile networks.

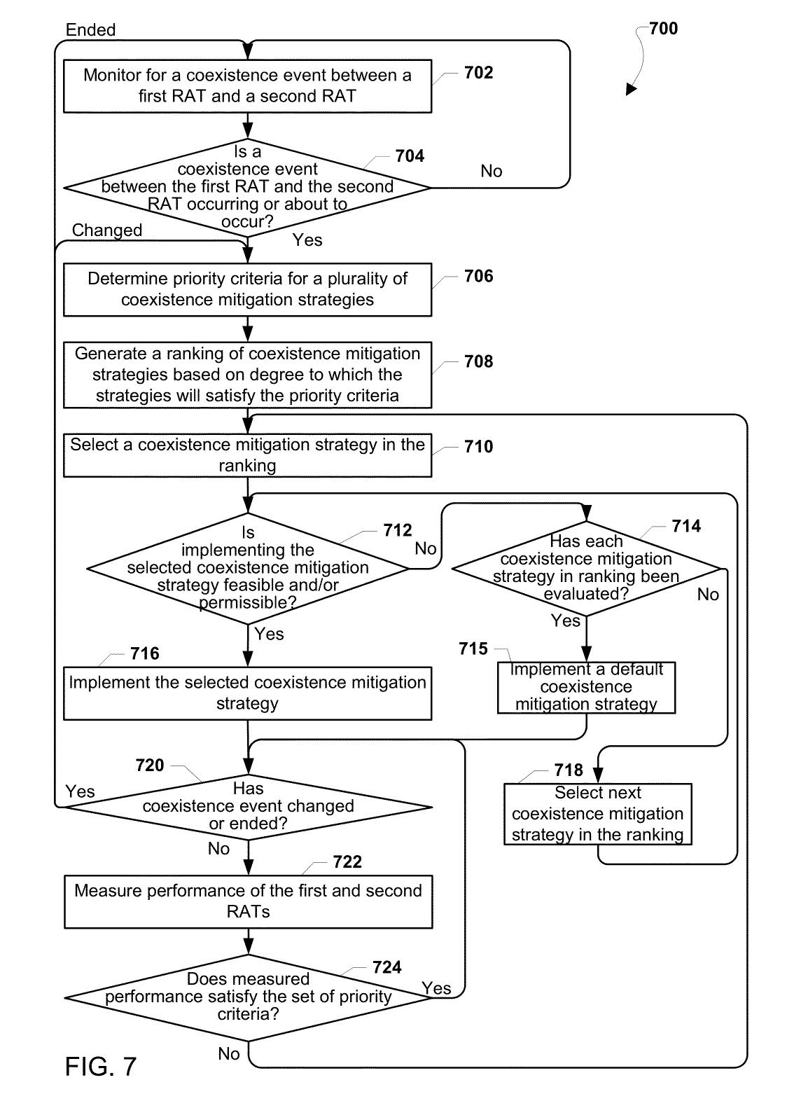

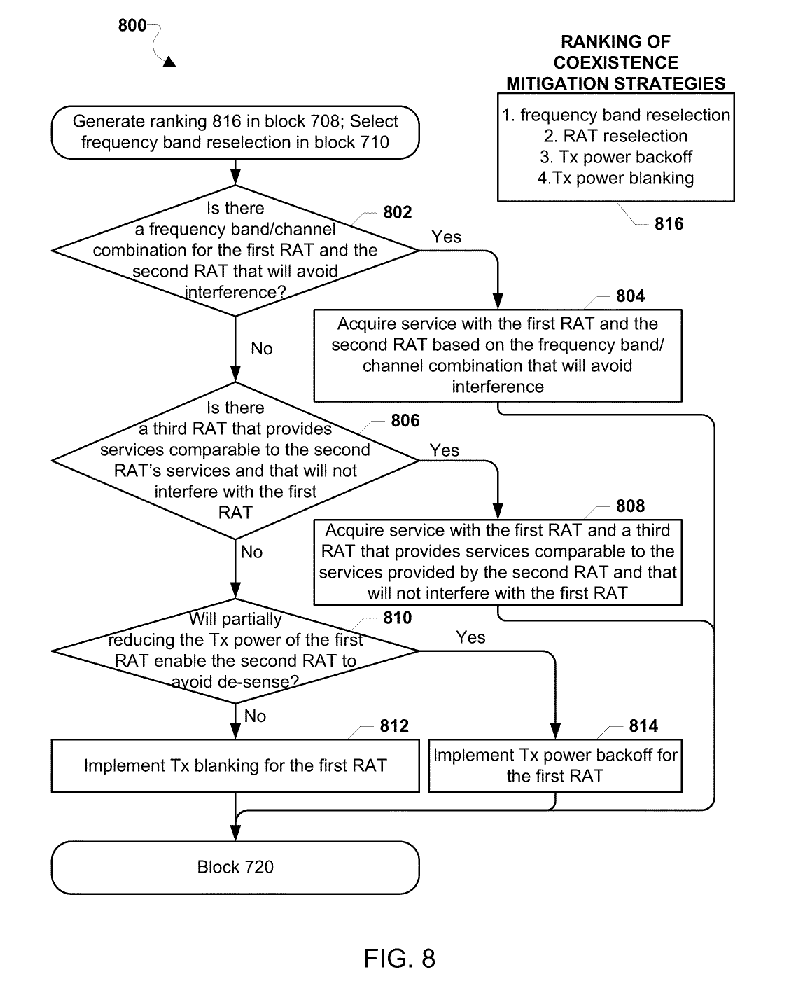

The mobile communication device 200 may include a coexistence management unit 230 configured to manage and/or schedule the RATs' utilization of the RF resources 218a, 218b. In some embodiments, the coexistence management unit 230 may be implemented within the general processor 206. In some embodiments, the coexistence management unit 230 may be implemented as a separate hardware component (i.e., separate from the general processor 206). In some embodiments, the coexistence management unit 230 may be implemented as a software application stored within the memory 214 and executed by the general processor 206. In some embodiments, the coexistence management unit 230 may select a set of priority criteria for mitigation strategies based on a current or impending coexistence event and current device state/activities, rank or otherwise generate a hierarchy of available coexistence mitigation strategies, and select and attempt to implement one or more of a plurality of coexistence mitigation strategies based on various criteria (see, e.g., FIGS. 7-8).

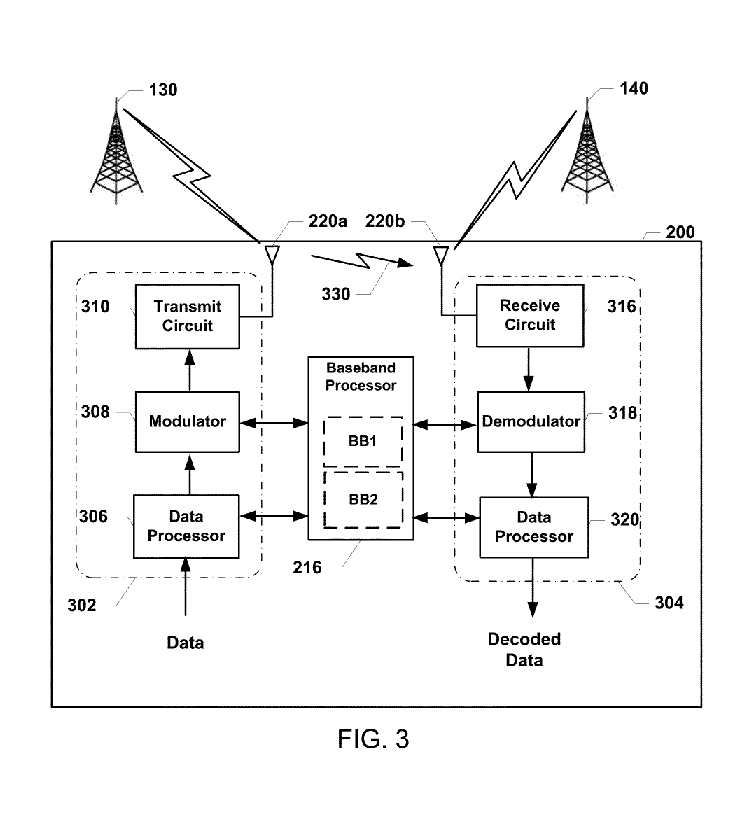

FIG. 3 is a block diagram of transmit and receive components in separate RF resources on the mobile communication device 200 described above with reference to FIGS. 1-2, according to various embodiments. With reference to FIGS. 1-3, a transmitter 302 may be part of the RF resource 218a, and a receiver 304 may be part of the RF resource 218b. In some embodiments, the transmitter 302 may include a data processor 306 that may format, encode, and interleave data to be transmitted. The transmitter 302 may include a modulator 308 that modulates a carrier signal with encoded data, such as by performing Gaussian minimum shift keying (GMSK). One or more transmit circuits 310 may condition the modulated signal (e.g., by filtering, amplifying, and upconverting) to generate an RF modulated signal for transmission. The RF modulated signal may be transmitted to the first base station 130 via the first wireless antenna 220a, for example.

At the receiver 304, the second wireless antenna 220b may receive RF modulated signals from the second base station 140 on the second wireless antenna 220b. However, the second wireless antenna 220b may also receive some RF signaling 330 from the transmitter 302, which may ultimately compete with the desired signal received from the second base station 140. One or more receive circuits 316 may condition (e.g., filter, amplify, and downconvert) the received RF modulated signal, digitize the conditioned signal, and provide samples to a demodulator 318. The demodulator 318 may extract the original information-bearing signal from the modulated carrier wave, and may provide the demodulated signal to a data processor 320. The data processor 320 may de-interleave and decode the signal to obtain the original, decoded data, and may provide decoded data to other components in the mobile communication device 200. Operations of the transmitter 302 and the receiver 304 may be controlled by a processor, such as the baseband modem processor 216. In various embodiments, each of the transmitter 302 and the receiver 304 may be implemented as circuitry that may be separated from their corresponding receive and transmit circuitries (not shown). Alternatively, the transmitter 302 and the receiver 304 may be respectively combined with corresponding receive circuitry and transmit circuitry, for example, as transceivers associated with the SIM-1 204a and the SIM-2 204b.

Receiver de-sense may occur when transmissions by a first RAT on the uplink (e.g., the RF signaling 330) interferes with receive activity on a different transmit/receive chain associated with a second RAT. The signals received by the second RAT may become corrupted and difficult or impossible to decode as a result of the de-sense or interference. Further, noise from the transmitter 302 may be detected by a power monitor (not shown) that measures the signal strength of surrounding cells, which may cause the mobile communication device 200 to falsely determine the presence of a nearby cell site.

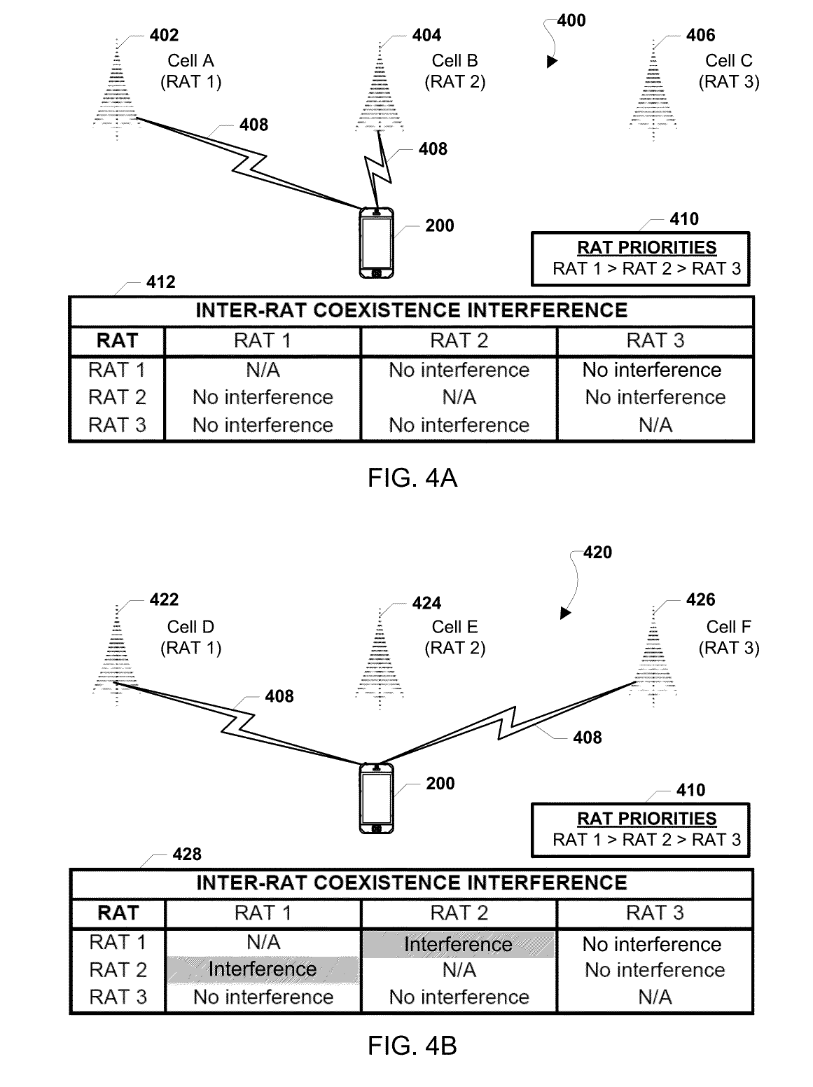

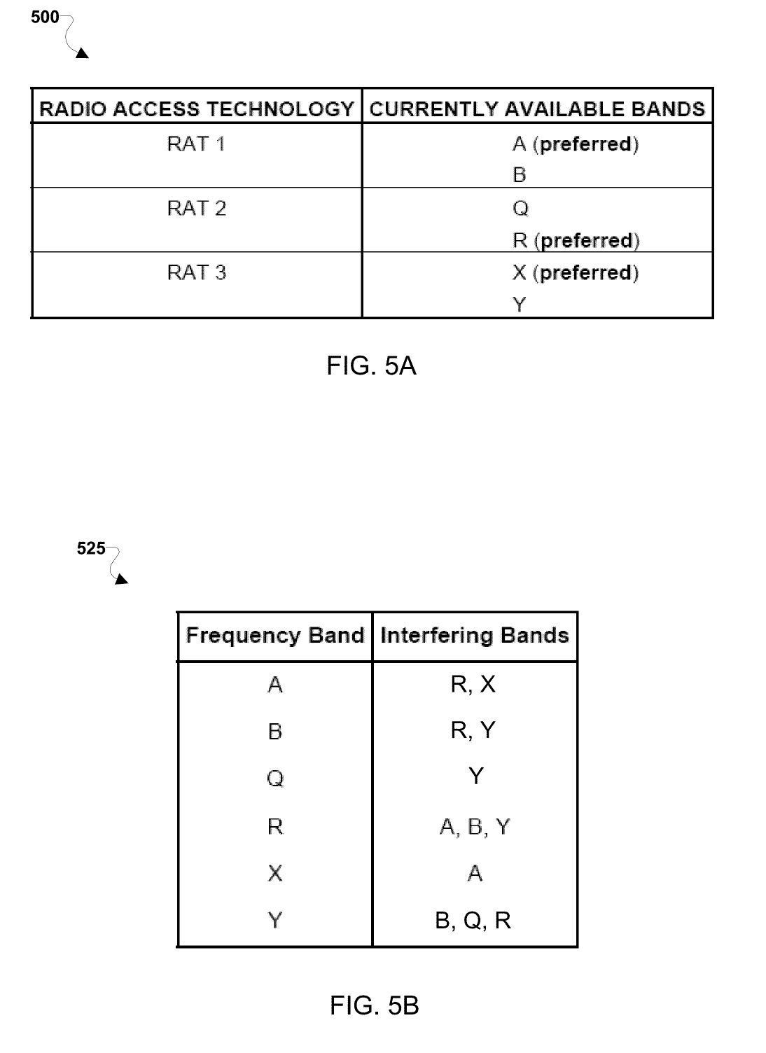

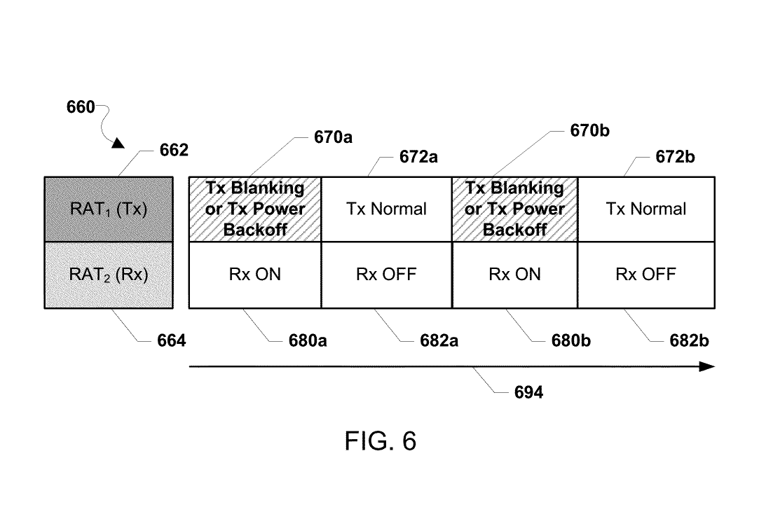

Because inter-RAT coexistence interference may severely degrade the performance of victim RATs affected by such interference, various coexistence mitigation strategies are currently implemented on mobile communication devices to avoid/mitigate coexistence interference between RATs. Some of these coexistence mitigation strategies include switching RATs to avoid inter-RAT coexistence interference (see, e.g., FIGS. 4A-4B), switching frequency band/channel combinations of RATs to receive service with non-interfering frequency bands/channels (see, e.g., FIGS. 5A-5B), and implementing Tx blanking and/or Tx power backoff on an aggressor RAT during a victim RAT's receptions activities (see, e.g., FIG. 6).

FIGS. 4A-4B are component block diagrams 400, 420 illustrating examples of avoiding coexistence events between RATs on a mobile communication device (e.g., the mobile communication device 200 of FIGS. 2-3) by acquiring service from RATs determined not to be at risk of inter-RAT coexistence interference. With reference to FIGS. 1-4B, the mobile communication device 200 may include two RF resources (e.g., the RF resources 218a, 218b) for use in acquiring services simultaneously via any two of a first RAT (labeled in FIGS. 4A-4B as “RAT 1”), a second RAT (labeled in FIGS. 4A-4B as “RAT 2”), and a third RAT (labeled in FIGS. 4A-4B as “RAT 3”). As described, the RATs on the mobile communication device 200 may be associated with the same subscription/SIM or with two or more different subscriptions.

For example, the mobile communication device 200 may be within service range of a first cell 402 (labeled in FIG. 4A as “Cell A”) that is associated with the first RAT, a second cell 404 (labeled in FIG. 4A as “Cell B”) associated with the second RAT, and a third cell 406 (labeled in FIG. 4A as “Cell C”) associated with the third RAT.

In some embodiments, the mobile communication device 200 may reference an interference data table (e.g., interference data table 412) before acquiring service with the RATs to determine whether there is a likelihood of inter-RAT coexistence interference occurring between two or more RATs. An interference data table may include various types of information that may enable a device processor (e.g., the general processor 206, the baseband modem processor 216, the coexistence management unit 230, a separate controller, and/or the like) on the mobile communication device 200 to determine whether two (or more) RATs are at risk of inter-RAT coexistence interference, such as a list of interfering frequency bands/channels between RATs (e.g., as described with reference to FIGS. 5A-5B). The interferences tables and/or the information included in the tables may be preloaded on the mobile communication device 200, such as by the original equipment manufacturer of the mobile communication device 200. The interference tables may also be received via user input, from a server, from one or more mobile networks associated with one or more subscriptions on the mobile communication device 200, etc.

In the example illustrated in FIG. 4A, the mobile communication device 200 may reference the interference data table 412 to determine that there is no likelihood of inter-RAT coexistence interference occurring between any of the first, second, and third RATs. In other words, the mobile communication device 200 may determine that any two of the first, second, and third RATs would be able to operate without experiencing and/or causing de-sense.

With reference to FIGS. 1-4A, in some embodiments, the mobile communication device 200 may determine an order in which the RATs are utilized to receive service. In some embodiments, the mobile communication device 200 may maintain a priority list 410 of the first, second, and third RATs used to determine the order in which the RATs are utilized to receive service. For example, the priority list 410 may list the first RAT as having the highest priority, followed by the second RAT and the third RAT, respectively. As the mobile communication device 200 may only support two simultaneous network connections, the mobile communication device 200 may attempt to acquire service with the first RAT and the second RAT based on the priority list 410 because the first and second RATs have the highest priorities and are also not at risk of experiencing or causing inter-RAT coexistence interference. The mobile communication device 200 may not attempt to acquire service from the third cell 406 via the third RAT because the third RAT has the lowest priority of the three RATs on the mobile communication device 200.

Thus, based on the higher priorities of the first and second RATs, the mobile communication device 200 may communicate over wireless connections 408 with the first cell 402 and the second cell 404 via the first and second RATs, respectively.

In the example illustrated in FIG. 4B, the mobile communication device 200 may have changed locations and now may be within service range of a fourth cell 422 (labeled in FIG. 4B as “Cell D”) associated with the first RAT, a fifth cell 424 (labeled in FIG. 4B as “Cell E”) associated with the second RAT, and a sixth cell 426 (labeled in FIG. 4B as “Cell F”) associated with the third RAT. As described, the mobile communication device 200 may maintain the priority list 410, indicating that the first RAT has the highest priority, followed by the second RAT and the third RAT, respectively.

With reference to FIGS. 1-4B, prior to attempting to acquire service with any of the first, second, and third RATs, the mobile communication device 200 may reference an interference data table 428 to determine whether there is a likelihood of a coexistence event occurring between any of the RATs at the current location. As illustrated in the interference data table 428, the mobile communication device 200 may determine that there is a likelihood that the first RAT and second RAT will interfere with one another. Thus, while the first and second RATs have the highest priorities, acquiring service with the first and second RATs may cause the mobile communication device 200 to experience an overall degraded performance.

The mobile communication device 200 may reference the interference data table 428 to determine whether there is another RAT that may be used simultaneously with the first RAT (i.e., the highest priority RAT) without resulting in inter-RAT coexistence interference. As indicated in the interference data table 428, the mobile communication device 200 may determine that the first RAT and the third RAT do not interfere with each other. As a result, the mobile communication device 200 may establish wireless connections 408 with the fourth cell 422 and the sixth cell 426 to receive service via the first and third RATs, respectively.

In some embodiments, the mobile communication device 200 may continue acquiring service with the first and third RATs until the mobile communication device 200 determines that there is no longer a risk of inter-RAT coexistence interference between the first and second RATs, which may occur for example when the first RAT performs a handoff to another cell and/or when the new frequency bands/channels become available to the second RAT. In response to determining that the first and second RATs are no longer at risk of experiencing inter-RAT coexistence interference, the mobile communication device 200 may switch services from the third RAT to the second RAT because the second RAT has a higher priority. Thus, the mobile communication device 200 may avoid/prevent degraded RAT performance by temporarily receiving service with lower-priority RATs, and the mobile communication device 200 may revert back to receiving service from higher-priority RATs when those higher-priority RATs are no longer at risk of causing and/or experiencing a coexistence event.

While switching RATs to avoid interference may be effective in some circumstances, the mobile communication device may unable to switch RATs for various reasons. For example, there may be no networks and/or frequency bands/channels available for the third RAT (or fourth, fifth, etc. RATs), thereby preventing the mobile communication device from switching to another RAT to avoid de-sense. Further, many mobile communication devices may not support more than two RATs, which may prevent these mobile communication devices from using this coexistence mitigation strategy to avoid de-sense between the first RAT and the second RAT.

Thus, while switching RATs may be effectively implemented to avoid/mitigate de-sense in circumstances in which the mobile communication device has plentiful access to network resources and/or more than two RATs, switching RATs may be a poor solution to de-sense and/or impossible to implement under other circumstances. Further, because switching RATs may require the mobile communication device to terminate service with one RAT and establish service with another RAT, the user may experience a drop in service. Thus, even in some circumstances in which switching RATs is possible, the user, original equipment manufacturer, network operator, or other entities may have set preferences on the mobile communication device (e.g., via an input, signal, bit, etc.) that specifies that switching RATs may only be desirable as a last resort when other coexistence mitigation strategies have failed.

In some embodiments, the device processor may take some or all of these priority criteria into account when determining the priority of RAT reselection relative to other coexistence mitigation strategies (see, e.g., FIG. 7).

As described, a mobile communication device may anticipate/predict when a coexistence event will occur between two RATs by performing a look-up operation in an interference data table stored in memory (e.g., the memory 214, memory in the coexistence management unit 230, or the like). FIGS. 5A-5B illustrate example data tables 500, 525 that a mobile communication device (e.g., the mobile communication devices 110, 120, 200 described with reference to FIGS. 1-4B) may reference to anticipate and avoid potential inter-RAT coexistence interference.

With reference to FIGS. 1-5B, the example data table 500 may include a list of the frequency bands currently available to (i.e., within service range of) each of three RATs operating on the mobile communication device. The information may indicate that a first RAT operating on the mobile communication device (labeled in FIG. 5A as “RAT 1”) is receiving signals from and thus is capable of utilizing bands A and B; that a second RAT on the device (labeled in FIG. 5A as “RAT 2”) is receiving signals from and thus is capable of utilizing bands Q and R; and that a third RAT on the device (labeled in FIG. 5A as “RAT 3”) is receiving signals from and thus is capable of utilizing bands X and Y.

The data table 500 may also indicate each RAT's preferred frequency band(s). For example, the first RAT's preferred frequency band/channel may be band A, the second RAT's preferred frequency band/channel may be band R, and the third RAT's preferred frequency band/channel may be band X. In some embodiments, a RAT's preferred frequency band/channel may be a predetermined band/channel through which the RAT may receive the best service, data throughput, etc. In such embodiments, the mobile communication device may attempt to acquire service with a RAT's preferred frequency band/channel when possible and may use other, non-preferred bands/channels in the event that a preferred frequency is unavailable or interferes with the frequency band/channel of another RAT, such as a higher priority RAT.

In some embodiments, a device processor (e.g., the general processor 206, the baseband modem processor 216, the coexistence management unit 230, a separate controller, and/or the like) may identify the available frequency bands for each RAT by performing a frequency band scan to detect the frequency bands available for each RAT at the current location. In some embodiments, the device processor may receive information regarding available frequency bands for each RAT operating on the mobile communication device directly from each of those RATs and/or indirectly from those RATs' respective networks.

As described, frequency bands used by two or more RATs may interfere with each other, thereby introducing the possibility that inter-RAT coexistence interference may occur on the mobile communication device and may degrade one or more RATs' performance. In the example, the band interference data table 525 may include information regarding frequency bands that interfere with each other for use in determining whether there is a likelihood that a coexistence event will occur on the mobile communication device. For example, if frequency band R is currently available to the second RAT, the device processor may use the band interference data table 525 to determine that frequency bands A, B, and Y will interfere with the band R. Thus, by using the band interference data table 525, the device processor may easily determine the frequency bands that interfere between two or more RATs in order to avoid the potential for interference between those RATs.

In some embodiments, the device processor may utilize the information included in each of the data tables 500, 525 to identify potentially problematic combinations of frequency bands. For example, the device processor may perform table lookups of the first and second RATs' available frequency bands (e.g., as illustrated in the data table 500) in the band interference data table 525 and determine that the available frequency band R associated with the second RAT interferes with the first RAT's available frequency bands A and B. However, the device processor may also determine that the frequency band Q available to the second RAT does not interfere with either frequency bands A or B. Thus, the device processor may determine that there is a combination of frequency bands for the first RAT and the second RAT that would avoid inter-RAT coexistence based on those the table look-up operations (i.e., frequency bands A and Q or B and Q), and may configure the second RAT to utilize frequency band Q to avoid being de-sensed by (or de-sensing) the first RAT.

Two bands may interfere with each other in the event that the frequency bands are the same, overlap, and/or otherwise have characteristics (e.g., be harmonics or subharmonics thereof) known to cause interference with each other. Such interference can be determined in advance by a manufacturer of the mobile communication device, a manufacturer of the modems, network operators, and independent parties (e.g., protocol organization, independent testing labs, etc.). Thus, the band interference data table 525 may be predefined and loaded in memory of the mobile communication device, within one or more of the SIMs, or within a modem within the mobile communication device. In some embodiments the mobile communication device may be configured to generate a band interference data table by recognizing when de-sense is occurring and recording the frequency bands in use at the time by each of the RATs.

In various embodiments, a band interference data table (e.g., the data tables 500, 525) may be organized according to a variety of data structures or formats, such as an associative list, a database, a linked list, etc. For example, the band interference data table 525 is a simple data table in which a first frequency band can be used as a look-up data field to determine the frequency bands that will interfere with that frequency band.

As described with reference to RAT reselection (see FIGS. 4A-4B), selecting a non-interfering combination of frequency bands may be effectively implemented to mitigate or avoid de-sense on the mobile communication device. Particularly, the mobile communication device may quickly identify one or more non-interfering frequency bands and may configure the RATs to move to frequency bands that do not interfere with each other, thereby improving overall performance on the mobile communication device.

However, while implementing frequency-band reselection may be effective, this coexistence mitigation strategy requires support from the network, the availability of non-interfering frequency bands, and various other constraints that may reduce the effectiveness of this strategy or make this strategy inappropriate, impractical, or impossible to implement given the current conditions of the mobile communication device and/or nearby networks.

In some embodiments, implementing frequency-band reselection may be frustrated by the preferences of network operators, the user, original equipment manufacturers, etc. For example, network operators may prefer mobile communication devices to receive service via certain frequency bands in certain geographic areas and may disfavor or disallow the use of other frequency bands in those areas. Thus, while performing frequency-band reselection in one location (area, cell zone, network, etc.) may be highly desirable (i.e., a high priority), performing frequency-band reselection in another location may have a low desirability or may not be permitted (i.e., a low priority).

In light of these potential benefits and/or limitations of implementing frequency-band reselection (e.g., based on the above priority criteria), the device processor may determine the priority of frequency-band reselection in relation to other potential coexistence mitigation strategies when selecting a coexistence mitigation strategy that may be the most successful in avoiding de-sense given current conditions (see FIG. 7). In various embodiments, this may be accomplished by selecting a set of mitigation strategy priority criteria based on the circumstances of a coexistence event, including location, network conditions, device activities, device state, subscription priorities, etc., and using that circumstance-appropriate set of selection/priority criteria to rank order or otherwise generate a hierarchy of the available coexistence mitigation strategies.

FIG. 6 is a block diagram 600 demonstrating an RF coexistence event in which a device processor (e.g., the general processor 206 of FIG. 2, the baseband modem processor 216, the coexistence management unit 230, a separate controller, and/or the like) on the mobile communication device (e.g., the mobile communication devices 110, 120, 200 described with reference to FIGS. 1-4) has configured a first RAT 662 (labeled in FIG. 6 as “RAT₁”) to implement Tx blanking or Tx power backoff during the reception activities of a second RAT 664 (labeled in FIG. 6 as “RAT₂”). With reference to FIGS. 1-6, the first RAT 662 may be attempting to transmit at the same time that the second RAT 664 is attempting to receive transmissions, resulting in a an coexistence event 694 as the first RAT's 662 transmissions may de-sense the reception activities of the second RAT 664. Therefore, the mobile communication device may configure the first RAT 662 to implement either Tx blanking or Tx power backoff during the reception activities of the second RAT.

For example, as illustrated in the block diagram 660, during a period of time during which the second RAT 664 is receiving (e.g., during reception periods 680a and 680b), the mobile communication device (e.g., via the device processor) may configure the first RAT to implement Tx blanking or Tx power backoff during periods of time that correspond with the reception periods 680a and 680b (i.e., Tx blanking/Tx power backoff periods 670a and 670b). Similarly, during periods in which the second RAT 664 is not performing reception activities (e.g., non-reception periods 682a and 682b), the mobile communication device may enable the first RAT 662 to transmit normally (i.e., transmission periods 672a and 672b).

In some instances, implementing Tx power backoff may effectively mitigate or avoid de-sense without affecting (or substantially affecting) the mobile communication device's typical operations. For example, the mobile communication device may reduce the transmit power of the first RAT just enough to prevent the first RAT from de-sensing the second RAT without needing to change frequency bands, to contact the first RAT's network, etc. In some other circumstances, network operators may disfavor (or disallow) the mobile communication device from implementing Tx power backoff because reducing the first RAT's transmit power may lead to a loss in coverage and data throughput or inconsistent signal measurements.

Similarly, implementing Tx blanking may be a simple and effective way of avoiding de-sense by preventing the aggressor RAT from transmitting while the victim RAT is receiving transmissions. However, the effectiveness of Tx blanking may depend on the scheduling of the victim and/or aggressor RATs' networks. For example, for some networks, Tx blanking may reduce the aggressor RAT's data throughput by a comparatively small amount, whereas Tx blanking may significantly degrade data throughput in other networks. Further, each original equipment manufacturer/vendor may implement Tx blanking differently, causing the effectiveness of Tx blanking as a coexistence mitigation strategy to vary based on the specific type of mobile communication device on which Tx blanking is being implemented.

Thus, in determining the priority of Tx power backoff and/or Tx blanking in relation to various other coexistence mitigation strategies (e.g., RAT reselection and frequency band reselection), the device processor may consider the above factors and priority criteria that may impact the effectiveness of implementing these coexistence mitigation strategies (see, e.g., FIG. 7).

FIG. 7 illustrates a method 700 for attempting to select and implement a coexistence mitigation strategy in order to mitigate/avoid coexistence interference between a first RAT and a second RAT based on various criteria, preferences, priorities, etc. of a plurality of coexistence mitigation strategies according to some embodiments. The method 700 may be implemented with a processor (e.g., the general processor 206 of FIG. 2, the baseband modem processor 216, the coexistence management unit 230, a separate controller, and/or the like) of a mobile communication device (e.g., the mobile communication devices 110, 120, 200 described with reference to FIGS. 1-4).

With reference to FIGS. 1-7, the device processor may monitor for a coexistence event between the first RAT and the second RAT in block 702, and may continue monitoring for a coexistence event so long as a coexistence event between the first RAT and the second RAT is not occurring and is not about to occur (i.e., while determination block 704=“No”). In some embodiments, the device processor may monitor the transmission activities of the first RAT and the reception activities of the second RAT to determine whether there is a risk that the first RAT may de-sense the second RAT.

In response to determining that a coexistence event between the first RAT and the second RAT is occurring or is about to occur (i.e., determination block 704=“Yes”), the device processor may determine an appropriate set of priority criteria for the determined coexistence event to be used in ranking the plurality of coexistence mitigation strategies for selecting a strategy to implement during the coexistence event in block 706. In some embodiments, the plurality of coexistence mitigation strategies may include any combination of two or more of RAT reselection (see, e.g., FIGS. 4A-4B), frequency-band reselection (see, e.g., FIGS. 5A-5B), Tx power backoff, Tx blanking (see, e.g., FIG. 6), and/or other coexistence mitigation strategies. In such embodiments, the priority criteria may include various factors affecting the desirability, feasibility, and/or permissibility of performing one or more of the coexistence mitigation strategies and may include preferences, priorities, and/or other differentiating factors that may be used to distinguish each coexistence mitigation strategy as described. The priority criteria may include performance criteria for both the first RAT and the second RAT during the coexistence event. The performance criteria may include, but are not limited to, voice quality for the first and second RATs, data throughput of the first and second RATs (either individually or combined), the error rates for the first and second RATs, the transmission power of the first and second RATs, use of mobile device resources by the first and second RATs (e.g. memory usage, processor time, battery power), and use of network resources by the first and second RATs (e.g. bandwidth, load on certain frequency bands). For example, the performance criteria may include minimum thresholds for one or more performance parameters for one or all RATs. The priority criteria may reflect priorities or preferences for maximizing the performance of the first and second RATs during the coexistence event with respect to one or more performance criteria.

In some embodiments, the priority criteria selected in block 706 may reflect a measure of the expected usefulness of implementing or preference for using each of the plurality of coexistence mitigation strategies in the particular circumstances of the current or impending coexistence event. For instance, the selected priority criteria may include preferences received via input from the user, network operators, original equipment manufacturers, etc. In an example, the device processor may determine that implementing frequency-band reselection is not preferable based on received network operator preferences that indicate that the first RAT and the second RAT should use their preferred frequency bands even when those preferred frequency bands interfere with each other. In such an example, implementing frequency-band reselection may have a lower priority in comparison to other coexistence mitigation strategies.

In block 708, the device processor may generate a ranking or hierarchy of coexistence mitigation strategies based on a degree to which each coexistence mitigation strategy is predicted to satisfy the selected priority criteria during the current or impending coexistence event, such as by listing the highest priority/more-preferred coexistence mitigation strategies before lower priority/less-preferred strategies. For example, based on the priority criteria determined in block 706, the device processor may determine that frequency-band reselection is highly preferred because there are no known network operator objections to implementing that coexistence mitigation strategy, and the device processor may list frequency-band reselection before Tx blanking because Tx blanking is expected to cause a substantial reduction in the first RAT's data throughput. In some embodiments, the device processor may implement a tie-breaker algorithm or may set a predetermined ranking for the coexistence mitigation strategies in the event that two or more coexistence mitigation strategies have the same or substantial similar priorities.

The ranking or hierarchy of coexistence mitigation strategies may be based on the number of the selected priority criteria (i.e., the priority criteria determined in block 706) that each coexistence mitigation strategy is predicted to satisfy, with higher ranked coexistence mitigation strategies predicted to satisfy more priority criteria. Generating the ranking or hierarchy of coexistence mitigation strategies may include determining predicted values of one or more of the priority criteria for each of the plurality of coexistence mitigation strategies during the coexistence event. For example, the device processor may determine a predicted data throughput for the first RAT during the coexistence event for each coexistence mitigation strategy and compare the predicted data throughput to a data throughput threshold on the first RAT specified in one of the selected priority criteria. If a coexistence mitigation strategy has a predicted data throughput on the first RAT that is higher than the threshold priority criteria, then that coexistence mitigation strategy may be predicted to satisfy the data throughput priority criteria for the first RAT during the coexistence event.

In some embodiments, the device processor may be unable to confirm the ranking of a coexistence mitigation strategy (e.g., because the device processor lacks certain preference information from network operators). In such embodiments, the device processor may assign a predetermined ranking (e.g., a “default” ranking) for that coexistence mitigation strategy. For example, in the absence of other priority information, the device processor may list Tx blanking before Tx power backoff.

In block 710, the device processor may select a coexistence mitigation strategy based on the ranking or hierarchy of coexistence mitigation strategies. For example, the selected coexistence mitigation strategy may be the highest ranked coexistence mitigation strategy.

In determination block 712, the device processor may determine whether implementing the selected coexistence mitigation strategy is feasible and/or permissible under the circumstances of the current or impending coexistence event, such as by determining whether the current conditions, resources, etc. of the mobile communication device and/or nearby networks currently support the selected coexistence mitigation strategy. For example, in response to selecting frequency-band reselection, the device processor may identify the frequency bands that are currently available to each of the first and second RATs and may determine whether it is possible to switch frequency bands to avoid an interfering frequency band combination. In another example in which the selected coexistence mitigation strategy is RAT reselection, the device processor may determine whether a third (or fourth, fifth, etc.) RAT is available on the mobile communication and, if a third RAT is available, whether the third RAT may be used in combination with the first or second RATs to avoid de-sense. In another example in which Tx blanking has been selected, the device processor may determine whether implementing the selected coexistence mitigation strategy would cause the data throughput of the first RAT to fall below a minimum throughput threshold.

In some embodiments of the operations performed in determination block 712, the device processor may determine whether implementing the coexistence mitigation is permissible. For example, before implementing frequency-band reselection for the first RAT, the device processor may determine whether the first RAT's network will allow the first RAT to move to another frequency band. In such embodiments, the device processor may not implement a coexistence mitigation strategy that is feasible/permissible in response to determining that the coexistence mitigation strategy is not permissible.

In response to determining that the selected coexistence mitigation strategy is not feasible or permissible (i.e., determination block 712=“No”), the device processor may determine whether each coexistence mitigation strategy in the ranking has been evaluated, in determination block 714. In other words, the device processor may determine whether the device processor has evaluated for feasibility/permissibility or attempted to implement each coexistence mitigation strategy in the ranking or hierarchy of coexistence mitigation strategies.

In response to determining that each coexistence mitigation strategy in the ranking has not been selected (i.e., determination block 714=“No”), the device processor may select another coexistence mitigation strategy in the ranking in block 718, for example the next highest ranked coexistence mitigation strategy. The device processor may repeat the above operations in a loop by again determining whether implementing the coexistence mitigation strategy that is next in the ranking is permissible and/or feasible in determination block 712. For example (see FIG. 8), the ranking (e.g. an ordered list) may include frequency-band reselection, RAT reselection, Tx power backoff, and Tx blanking, respectively, and the device processor may attempt to implement each of these coexistence mitigation strategies in order. In summary, the device processor may incrementally evaluate each coexistence mitigation strategy in rank order for feasibility and permissibility until either a feasible and permissible coexistence mitigation strategy is identified or all coexistence mitigation strategies have been evaluated. The device processor may implement a highest ranked coexistence mitigation strategy determined to be feasible and permissible. If no ranked coexistence mitigation strategy is determined to be feasible and permissible, the device processor may implement a default coexistence mitigation strategy, such as suspending receive operations.

In response to determining that each coexistence mitigation strategy in the ranking has been evaluated or attempted (i.e., determination block 714=“Yes”), the device processor may implement a default coexistence mitigation strategy in block 715. The default coexistence mitigation strategy may be a predefined default strategy, the highest ranked strategy in the hierarchy of available coexistence mitigation strategies (even though it was previously rejected for some reason), the last implemented coexistence mitigation strategy (i.e., make no further changes in coexistence mitigation strategies), or no mitigation method at all. In other words, in response to determining that no coexistence mitigation strategy in the ranking is feasible and/or permissible, the device processor may implement a coexistence mitigation strategy by default (or no mitigation strategy).

In response to determining that implementing the selected coexistence mitigation strategy is feasible and/or permissible (i.e., determination block 712=“Yes”), the device processor may implement the selected coexistence mitigation strategy in block 716. For example, in response to determining that RAT reselection is feasible and permitted, the device processor may perform operations to terminate service with the second RAT and to initiate service with a third RAT that does not interfere with the first RAT (see FIGS. 4A-4B).

In determination block 720, the device processor may monitor the coexistence conditions between the first RAT and the second RAT to detect when the coexistence event ends or there is a change in the nature of the coexistence event. In response to determining that the coexistence event has ended or changed (i.e., determination block 720=“Yes”), the device processor may repeat the operations to determine an appropriate set of priority criteria in block 706 if the coexistence conditions changed or return to monitoring for the next coexistence event in block 702 if the current coexistence event has ended. A change in the coexistence event between the first RAT and the second RAT may affect the various priority criteria that were previously determined in block 706. For example, the mobile communication device may have entered a geographical area in which network operators permit disallow frequency-band reselection or a geographical area that utilizes different scheduling that may affect the effectiveness of Tx blanking. Thus, in order to ensure that suitable/appropriate coexistence mitigation strategy are evaluated for use under the current coexistence conditions, the device processor may again determine the priority criteria suitable for the current coexistence conditions in block 706 and use the newly determined priority criteria to select a coexistence mitigation strategy in blocks 708 through 724.

In response to determining that the coexistence event has not ended or changed, the device processor may measure the performance of the first RAT and the second RAT while implementing the selected or default coexistence mitigation strategy during the coexistence event in block 722 so that the actual performance(s) can be compared to the priority criteria. For example, if the priority criteria include the voice quality or data throughput of the first and second RATs, the device processor may measure the voice quality or data throughput of the first RAT and the second RAT during the coexistence event when the selected coexistence mitigation strategy is implemented.

In determination block 724, the device processor may determine whether the measured performances of the first RAT and the second RAT satisfy the determined priority criteria after implementing the selected coexistence mitigation strategy. In other words, device processor may determine whether the implemented coexistence mitigation strategy performs as well as predicted in block 708 when the device processor was generating the ranking of the coexistence mitigation strategies. For example, the measured parameters may be compared to performance thresholds for one or more parameters of one or both RATs that are specified in the determined priority criteria. For example, the device processor may measure the actual data throughput of the first RAT during the coexistence event and compare the measured throughput to a threshold data throughput of the first RAT specified by the priority criteria.

In response to determining that the measured performances of the first and second RATs satisfy the determined priority criteria (i.e. determination block 724=“Yes”) the device processor may repeat the operations of determining whether the coexistence event has changed or ended in determination block 720 and measuring performance of the first and second RATs in block 722. In other words, the device processor may continue to monitor the performances of the first and second RATs during the coexistence event to determine whether the measured performances of the first and second RATs continue to satisfy the priority criteria or the coexistence event ends or changes.

In response to determining that the measured performance of the first and second RATs does not satisfy the priority criteria (i.e. determination block 724=“No”), the device processor may select another coexistence mitigation strategy for implementation in block 710. In other words, when the device processor determines that the measured performance of the first and second RATs under the implemented coexistence mitigation strategy does not satisfy the priority criteria and the cause is not due to a change in the coexistence event, the device processor may implement another coexistence mitigation strategy. The device processor may select the next highest ranked coexistence mitigation strategy in the hierarchy of available coexistence mitigation strategies. The device processor may continue to implement different coexistence mitigation strategies until the measured performance of the first and second RATs satisfy the priority criteria (i.e., determination block 724=“Yes”) or all coexistence mitigation strategies have been evaluated in this manner (i.e., determination block 714=“Yes”). In other words, the device processor may evaluate the performance of the first and second RATs for each implemented coexistence mitigation strategy. When the performance of the first and second RATs does not satisfy the priority criteria, the device processor may implement the next highest coexistence mitigation strategy (if the strategy is feasible and permissible), and continue down the ranked order until either the first and second RATs satisfy the priority criteria for an implemented strategy or all strategies have been evaluated. Optionally, if a default coexistence mitigation strategy has been implemented in block 715, the device processor may continue to implement the default coexistence mitigation strategy because the other coexistence mitigation strategies may have been determined to be unfeasible, impermissible, or less effective than the default coexistence mitigation strategy.

FIG. 8 illustrates a method 800 for attempting to implement a coexistence strategy based on a ranking (e.g. an ordered list) of coexistence mitigation strategies according to some embodiments. The method 800 may be implemented with a processor (e.g., the general processor 206 of FIG. 2, the baseband modem processor 216, the coexistence management unit 230, a separate controller, and/or the like) of a mobile communication device (e.g., the mobile communication devices 110,120, 200 described with reference to FIGS. 1-4 and 6). The method 800 implements some embodiments of the operations performed in block 712-718 of the method 700 of FIG. 7.

With reference to FIGS. 1-8, in some embodiments, the device processor may perform the operations of the method 800 in response to generating a ranking 816 (e.g. an ordered list) in block 708 of the method 700. In such embodiments, the device processor may have previously determined (see, e.g., block 706 of the method 700) that frequency-band reselection has a higher priority than RAT reselection, that RAT reselection has a higher priority than Tx power backoff, and that TX power blanking has the lowest priority, and the device processor may have generated the ranking 816 based on those determined priority relationships. The ranking 816 may be based on a number of factors, such as a degree to which each coexistence mitigation strategy satisfies the priority criteria during the coexistence event. For example, the ranking 816 may be generated based on the number of priority criteria that each coexistence mitigation strategy is predicted to satisfy during the coexistence event, with higher ranked coexistence mitigation strategies predicted to satisfy more priority criteria. The priority criteria may include performance criteria for the first and second RATs during the coexistence event. The device processor may select a coexistence mitigation strategy to implement based on the order of the ranking 816. Thus, the device processor may have selected the highest ranked coexistence strategy listed first in the ranking 816 (i.e., frequency-band reselection) in block 710 of the method 700.

In determination block 802, the device processor may determine whether there is a frequency band/channel combination for the first RAT and the second RAT that will avoid interference. For example, the device processor may reference a data table of interfering frequency bands (e.g., the band interference data table 525) to determine whether there is a combination of frequency bands currently available to the first RAT and second RAT that are not at risk of interfering with each other.

In response to determining that there is a frequency band/channel combination for the first RAT and the second RAT that will avoid interference (i.e., determination block 802=“Yes”), the device processor may acquire service with the first RAT and the second RAT based on the frequency band/channel combination that will avoid interference in block 804.

In response to determining that there is no frequency band/channel combination for the first RAT and the second RAT that will avoid interference (i.e., determination block 802=“No”), the device processor may determine whether there is a third RAT that provides services that are comparable to the services provided by the second RAT and that will not interfere with the first RAT in determination block 806 (see, e.g., FIGS. 4A-4B). In other words, the device processor may determine whether it is possible/permissible to implement a next-highest-rank coexistence mitigation strategy (i.e., RAT reselection) in response to determining that the highest-priority coexistence mitigations strategy is not feasible/permissible (i.e., frequency-band reselection).

In response to determining that there is a third RAT that will not interfere with the first RAT and that the third RAT provides services that are comparable to the services provided by the second RAT (i.e., determination block 806=“Yes”), the device processor may acquire service with the first RAT and the third RAT that provides service comparable to the services provided by the second RAT and that will not interfere with the first RAT, in block 808.

In response to determining that there is no third RAT that will not interfere with the first RAT or that there is no third RAT that provides services comparable to the services provided by the second RAT (i.e., determination block 806=“No”), the device processor may determine whether partially reducing the Tx power of the first RAT (i.e., the next-highest-rank coexistence mitigation strategy) will enable the second RAT to avoid de-sense in determination block 810. In response to determining that partially reducing the Tx power of the first RAT will enable the second RAT to avoid de-sense (i.e., determination block 810=“Yes”), the device processor may implement Tx power backoff (see, e.g., FIG. 6) for the first RAT in block 814.

In response to determining that partially reducing the Tx power of the first RAT will not enable the second RAT to avoid de-sense (i.e., determination block 810=“No”), the device processor may implement Tx blanking for the first RAT in block 812. In other words, based on current conditions and priority criteria, the device processor may implement Tx blanking for the first RAT only as a last resort in response to determining that the other coexistence mitigation strategies in the ranking 816 are not feasible/permissible.

In response to implementing a coexistence mitigation strategy in block 804, 808, 812, or 814, the device processor may monitor the coexistence event and determine whether the coexistence event has changed or ended in determination block 720. If the coexistence event has not changed or ended, the device processor may measure the performance of the first RAT and the second RAT during the coexistence event in block 722 of the method 700.

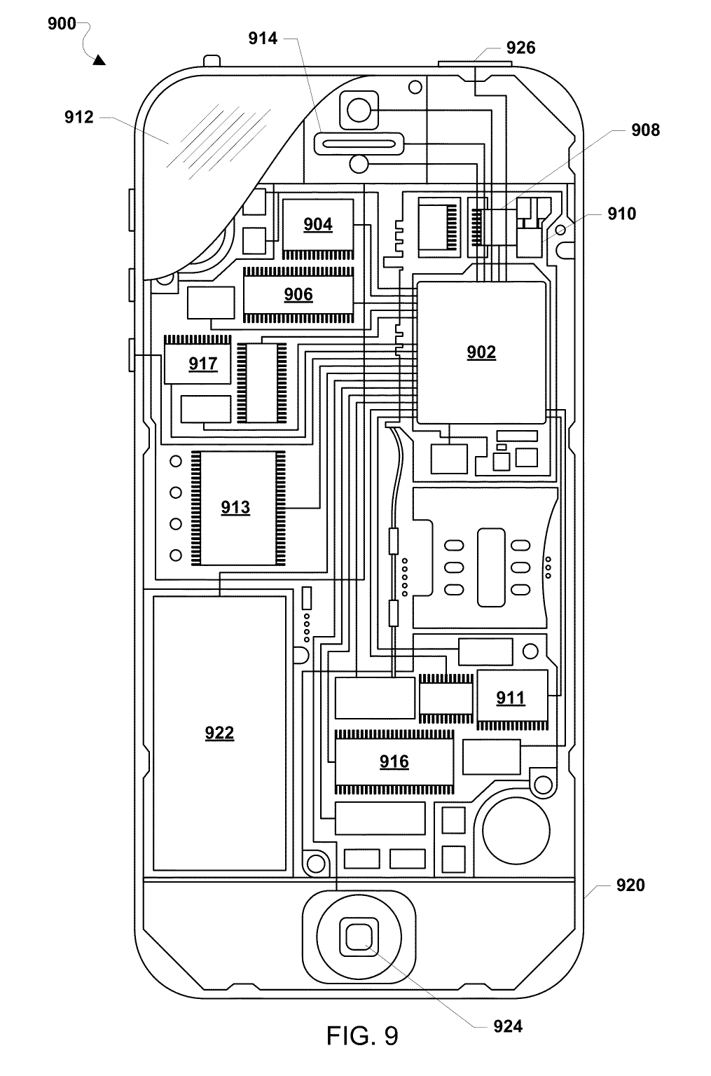

Various embodiments may be implemented in any of a variety of mobile communication devices, an example on which (e.g., mobile communication device 900) is illustrated in FIG. 9. According to various embodiments, the mobile communication device 900 may be similar to the mobile communication devices 110, 120, 200 as described above with reference to FIGS. 1-4. As such, the mobile communication device 900 may implement the methods 700, 800 in FIGS. 7-8.

Thus, with reference to FIGS. 1-9, the mobile communication device 900 may include a processor 902 coupled to a touchscreen controller 904 and an internal memory 906. The processor 902 may be one or more multi-core integrated circuits designated for general or specific processing tasks. The internal memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the mobile communication device 900 need not have touch screen capability.

The mobile communication device 900 may have one or more cellular network transceivers 908, 916 coupled to the processor 902 and to two or more antennae 910, 911 and configured for sending and receiving cellular communications. The transceivers 908, 916 and the antennae 910, 911 may be used with the above-mentioned circuitry to implement the various embodiment methods. The mobile communication device 900 may include one or more SIM cards (e.g., SIM 913) coupled to the transceivers 908, 916 and/or the processor 902 and configured as described above.

The mobile communication device 900 may also include speakers 914 for providing audio outputs. The mobile communication device 900 may also include a housing 920, constructed of a plastic, metal, or a combination of materials, for containing all or some of the components discussed herein. The mobile communication device 900 may include a power source 922 coupled to the processor 902, such as a disposable or rechargeable battery. The rechargeable battery may also be coupled to the peripheral device connection port to receive a charging current from a source external to the mobile communication device 900. The mobile communication device 900 may also include a physical button 924 for receiving user inputs. The mobile communication device 900 may also include a power button 926 for turning the mobile communication device 900 on and off.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for selecting a coexistence mitigation strategy in response to detecting an occurrence of a coexistence event between a first radio access technology (RAT) and a second RAT in a mobile communication device, comprising:
determining a first set of priority criteria for a plurality of coexistence mitigation strategies during the coexistence event, wherein the first set of priority criteria includes performance criteria of the first RAT and the second RAT, respectively;
determining a first ranking for the plurality of coexistence mitigation strategies based on a degree to which each coexistence mitigation strategy satisfies the first set of priority criteria during the coexistence event;
implementing a highest ranked coexistence mitigation strategy in the first ranking;
determining, for each implemented coexistence mitigation strategy, whether measured performance of the first RAT and the second RAT satisfy the first set of priority criteria after implementing the coexistence mitigation strategy; and
implementing a next highest ranked coexistence mitigation strategy in the first ranking when the measured performance of the first and second RAT does not satisfy the first set of priority criteria.

2. The method of claim 1, wherein the first set of priority criteria includes one or more parameters of voice quality, data throughput, error rate, transmission power, mobile communication device resources, and network resources.

3. The method of claim 1, wherein determining the first ranking comprises determining predicted values of one or more of the first set of priority criteria for each of the plurality of coexistence mitigation strategies during the coexistence event.

4. The method of claim 1, wherein the mobile communication device is a multi-Subscriber-Identity-Module (SIM), multi-active mobile communication device.

5. The method of claim 1, further comprising:
determining whether a change in the coexistence event between the first RAT and the second RAT has occurred;
determining a second set of priority criteria for the plurality of coexistence mitigation strategies in response to determining that a change in the coexistence event between the first RAT and the second RAT has occurred, wherein the second set of priority criteria includes performance criteria of the first RAT and the second RAT, respectively;
determining a second ranking for the plurality of coexistence mitigation strategies based on a degree to which each coexistence mitigation strategy satisfies the second set of priority criteria during the changed coexistence event; and
implementing a highest ranked coexistence mitigation strategy in the second ranking in response to determining a change in the coexistence event.

6. The method of claim 1, wherein the plurality of coexistence mitigation strategies comprises any combination of two or more of:
frequency-band reselection;
RAT reselection;
transmit power backoff; and
transmit power blanking.

7. The method of claim 1, wherein determining a first set of priority for each of a plurality of coexistence mitigation strategies during the coexistence event comprises ranking the plurality of coexistence mitigation strategies according to a number of priority criteria in the first set of priority criteria that each of the plurality of coexistence mitigation strategies is predicted to satisfy during the coexistence event.

8. The method of claim 1, wherein implementing a highest ranked coexistence mitigation strategy in the first ranking comprises:
determining whether implementing the highest ranked coexistence mitigation strategy is feasible and permissible; and
implementing the highest ranked coexistence mitigation strategy in response to determining that the highest ranked coexistence mitigation strategy is feasible and permissible.

9. The method of claim 8, further comprising:
determining whether implementing a next highest ranked coexistence mitigation strategy is feasible and permissible in response to determining that implementing the highest ranked coexistence mitigation strategy is at least one of not feasible and not permissible; and
implementing the next highest coexistence mitigation strategy in response to determining that the next highest ranked coexistence mitigation strategy is feasible and permissible.

10. The method of claim 8, further comprising in response to determining that the highest ranked coexistence mitigation strategy is at least one of not feasible and not permissible:
incrementally evaluating each coexistence mitigation strategy in rank order for feasibility and permissibility until either a feasible and permissible coexistence mitigation strategy is identified or all coexistence mitigation strategies have been evaluated;
implementing a highest ranked coexistence mitigation strategy determined to be feasible and permissible; and
implementing a default coexistence mitigation strategy if all coexistence mitigation strategies have been evaluated and none are determined to feasible and permissible.

11. A mobile communication device, comprising:
a plurality of radio frequency resources configured to support a first radio access technology (RAT) and a second RAT; and
a processor coupled to the plurality of radio frequency resources, wherein the processor is configured with processor-executable instructions to perform operations in response to detecting an occurrence of a coexistence event between the first RAT and the second RAT, the operations comprising:
determining a first set of priority criteria for a plurality of coexistence mitigation strategies during the coexistence event, wherein the first set of priority criteria includes performance criteria of the first RAT and the second RAT, respectively;
determining a first ranking for the plurality of coexistence mitigation strategies based on a degree to which each coexistence mitigation strategy satisfies the first set of priority criteria during the coexistence event;
implementing a highest ranked coexistence mitigation strategy in the first ranking;
determining, for each implemented coexistence mitigation strategy, whether measured performance of the first RAT and the second RAT satisfy the first set of priority criteria after implementing the coexistence mitigation strategy; and
implementing a next highest ranked coexistence mitigation strategy in the first ranking when the measured performance of the first and second RAT does not satisfy the first set of priority criteria.

12. The mobile communication device of claim 11, wherein the first set of priority criteria includes one or more parameters of voice quality, data throughput, error rate, transmission power, mobile communication device resources, and network resources.

13. The mobile communication device of claim 11, wherein the processor is configured with processor-executable instructions to perform operations such that determining the first ranking comprises determining predicted values of one or more of the first set of priority criteria for each of the plurality of coexistence mitigation strategies during the coexistence event.

14. The mobile communication device of claim 11, wherein the processor is further configured with processor-executable instructions to perform operations comprising:
determining whether a change in the coexistence event between the first RAT and the second RAT has occurred;
determining a second set of priority criteria for the plurality of coexistence mitigation strategies in response to determining that a change in the coexistence event between the first RAT and the second RAT has occurred, wherein the second set of priority criteria includes performance criteria of the first RAT and the second RAT, respectively;
determining a second ranking for the plurality of coexistence mitigation strategies based on a degree to which each coexistence mitigation strategy satisfies the second set of priority criteria during the changed coexistence event; and
implementing a highest ranked coexistence mitigation strategy in the second ranking in response to determining a change in the coexistence event.

15. The mobile communication device of claim 11, wherein the plurality of coexistence mitigation strategies comprises any combination of two or more of:
frequency-band reselection;
RAT reselection;
transmit power backoff; and
transmit power blanking.

16. The mobile communication device of claim 11, wherein the processor is configured with processor-executable instructions to perform operations such that determining a first set of priority for each of a plurality of coexistence mitigation strategies during the coexistence event comprises:
ranking the plurality of coexistence mitigation strategies according to a number of priority criteria in the first set of priority criteria that each of the plurality of coexistence mitigation strategies is predicted to satisfy during the coexistence event.

17. The mobile communication device of claim 11, wherein the processor is configured with processor-executable instructions to perform operations such that implementing a highest ranked coexistence mitigation strategy in the first ranking comprises:
determining whether implementing the highest ranked coexistence mitigation strategy is feasible and permissible; and
implementing the highest ranked coexistence mitigation strategy in response to determining that the highest ranked coexistence mitigation strategy is feasible and permissible.

18. The mobile communication device of claim 17, wherein the processor is further configured with processor-executable instructions to perform operations comprising:
determining whether implementing a next highest ranked coexistence mitigation strategy is feasible and permissible in response to determining that implementing the highest ranked coexistence mitigation strategy is at least one of not feasible and not permissible; and
implementing the next highest coexistence mitigation strategy in response to determining that the next highest ranked coexistence mitigation strategy is feasible and permissible.

19. The mobile communication device of claim 17, wherein in response to determining that the highest ranked coexistence mitigation strategy is at least one of not feasible and not permissible, the processor is further configured with processor-executable instructions to perform operations comprising:
incrementally evaluating each coexistence mitigation strategy in rank order for feasibility and permissibility until either a feasible and permissible coexistence mitigation strategy is identified or all coexistence mitigation strategies have been evaluated;
implementing a highest ranked coexistence mitigation strategy determined to be feasible and permissible; and
implementing a default coexistence mitigation strategy if all coexistence mitigation strategies have been evaluated and none are determined to feasible and permissible.

20. A non-transitory processor-readable storage medium having stored thereon processor-executable instructions configured to cause a processor of a mobile communication device to perform operations in response to detecting an occurrence of a coexistence event between a first radio access technology (RAT) and a second RAT on the mobile communication device, the operations comprising:
determining a first set of priority criteria for a plurality of coexistence mitigation strategies during the coexistence event, wherein the first set of priority criteria includes performance criteria of the first RAT and the second RAT, respectively;
determining a first ranking for the plurality of coexistence mitigation strategies based on a degree to which each coexistence mitigation strategy satisfies the first set of priority criteria during the coexistence event;
implementing a highest ranked coexistence mitigation strategy in the first ranking;
determining, for each implemented coexistence mitigation strategy, whether measured performance of the first RAT and the second RAT satisfy the first set of priority criteria after implementing the coexistence mitigation strategy; and
implementing a next highest ranked coexistence mitigation strategy in the first ranking when the measured performance of the first and second RAT does not satisfy the first set of priority criteria.

21. The non-transitory processor-readable storage medium of claim 20, wherein the first set of priority criteria includes one or more parameters of voice quality, data throughput, error rate, transmission power, mobile communication device resources, and network resources.

22. The non-transitory processor-readable storage medium of claim 20, wherein the stored processor-executable software instructions are configured such that determining the first ranking comprises determining predicted values of one or more of the first set of priority criteria for each of the plurality of coexistence mitigation strategies during the coexistence event.

23. The non-transitory processor-readable storage medium of claim 20, wherein the stored processor-executable software instructions are configured to cause the processor to perform operations further comprising:
determining whether a change in the coexistence event between the first RAT and the second RAT has occurred;
determining a second set of priority criteria for the plurality of coexistence mitigation strategies in response to determining that a change in the coexistence event between the first RAT and the second RAT has occurred, wherein the second set of priority criteria includes performance criteria of the first RAT and the second RAT, respectively;
determining a second ranking for the plurality of coexistence mitigation strategies based on a degree to which each coexistence mitigation strategy satisfies the second set of priority criteria during the changed coexistence event; and
implementing a highest ranked coexistence mitigation strategy in the second ranking in response to determining a change in the coexistence event.

24. The non-transitory processor-readable storage medium of claim 20, wherein the plurality of coexistence mitigation strategies comprises any combination of two or more of:
frequency-band reselection;
RAT reselection;
transmit power backoff; and
transmit power blanking.

25. The non-transitory processor-readable storage medium of claim 20, wherein the stored processor-executable software instructions are configured such that determining a first set of priority for each of a plurality of coexistence mitigation strategies during the coexistence event comprises:
ranking the plurality of coexistence mitigation strategies according to a number of priority criteria in the first set of priority criteria that each of the plurality of coexistence mitigation strategies is predicted to satisfy during the coexistence event.

26. The non-transitory processor-readable storage medium of claim 20, wherein the stored processor-executable software instructions are configured such that implementing a highest ranked coexistence mitigation strategy in the first ranking comprises:
determining whether implementing the highest ranked coexistence mitigation strategy is feasible and permissible; and
implementing the highest ranked coexistence mitigation strategy in response to determining that the highest ranked coexistence mitigation strategy is feasible and permissible.

27. The non-transitory processor-readable storage medium of claim 26, wherein the stored processor-executable software instructions are configured to cause the processor to perform operations further comprising:
determining whether implementing a next highest ranked coexistence mitigation strategy is feasible and permissible in response to determining that implementing the highest ranked coexistence mitigation strategy is at least one of not feasible and not permissible; and
implementing the next highest coexistence mitigation strategy in response to determining that the next highest ranked coexistence mitigation strategy is feasible and permissible.

28. The non-transitory processor-readable storage medium of claim 26, wherein in response to determining that the highest ranked coexistence mitigation strategy is at least one of not feasible and not permissible, the stored processor-executable software instructions are configured to cause the processor to perform operations further comprising:
incrementally evaluating each coexistence mitigation strategy in rank order for feasibility and permissibility until either a feasible and permissible coexistence mitigation strategy is identified or all coexistence mitigation strategies have been evaluated;
implementing a highest ranked coexistence mitigation strategy determined to be feasible and permissible; and
implementing a default coexistence mitigation strategy if all coexistence mitigation strategies have been evaluated and none are determined to feasible and permissible.

29. A mobile communication device, wherein upon detecting an occurrence of a coexistence event between a first radio access technology (RAT) and a second RAT the mobile communication device comprises:
means for determining a first set of priority criteria for a plurality of coexistence mitigation strategies during the coexistence event, wherein the first set of priority criteria includes performance criteria of the first RAT and the second RAT, respectively;
means for determining a first ranking for the plurality of coexistence mitigation strategies based on a degree to which each coexistence mitigation strategy satisfies the first set of priority criteria during the coexistence event;
means for implementing a highest ranked coexistence mitigation strategy in the first ranking;
means for determining, for each implemented coexistence mitigation strategy, whether measured performance of the first RAT and the second RAT satisfy the first set of priority criteria after implementing the coexistence mitigation strategy; and
means for implementing a next highest ranked coexistence mitigation strategy in the first ranking when the measured performance of the first and second RAT does not satisfy the first set of priority criteria.

30. The mobile communication device of claim 29, wherein means for implementing a highest ranked coexistence mitigation strategy in the first ranking comprises:
means for incrementally evaluating each coexistence mitigation strategy in rank order for feasibility and permissibility until either a feasible and permissible coexistence mitigation strategy is identified or all coexistence mitigation strategies have been evaluated;
means for implementing a highest ranked coexistence mitigation strategy determined to be feasible and permissible; and
means for implementing a default coexistence mitigation strategy if all coexistence mitigation strategies have been evaluated and none are determined to feasible and permissible.
